(19) United States
(12) Patent Application Publication
(10) Pub. No.: US 2013/0002382 A1
(43) Pub. Date: Jan. 3, 2013

(54) MAGNETIC CUP ASSEMBLY HOLDING DEVICE WITH LOW MAGNETIC LEAKAGE FIELD

(76) Inventors: Bo Zhang, Lake Zurich, IL (US); Joseph S. Parat, Chicago, IL (US)

(21) Appl. No.: 13/464,086

(22) Filed: May 4, 2012

Related U.S. Application Data
(60) Provisional application No. 61/501,833, filed on Jun. 28, 2011.

(51) Int. Cl. H01F 7/00

(52) U.S. Cl. 335/285

(57) ABSTRACT

A magnetic cup assembly includes at least one of a plurality of magnets and a single magnet having multiple magnetic poles disposed inside a ferromagnetic material cup. The cup has a closed bottom and a open top. The poles of the magnet or magnets are arranged such that there is substantial magnetic neutrality above the open top.

### CROSS-REFERENCE TO RELATED APPLICATIONS

Priority is claimed from U.S. Provisional Application No. 61/501,833 filed on Jun. 28, 2011, which application is hereby incorporated by reference in its entirety.

### STATEMENT REGARDING FEDERALLY SPONSORED RESEARCH OR DEVELOPMENT

Not applicable.

### BACKGROUND

The disclosure relates to the field of devices that utilize magnetic attraction force to hold to a ferromagnetic member, or members; such as steel parts. More particularly, the device disclosed herein, by its design, focuses the magnetic attraction force in a certain direction, and minimizes magnetic field leakage in the surroundings to eliminate magnetic interference with magnetically sensitive electronic or magnetic devices proximate the device.

Magnetic holding devices are an application of magnetic attraction force between a device and a ferromagnetic member or ferromagnetic members. The magnetic attraction force can be generated by permanent magnets or electromagnets. The magnetic attraction force can be fairly strong, as a result of high magnetic field strength and high magnetic field gradient. Therefore many such devices present a strong magnetic field in the surrounding environment.

Such strong magnetic field in the proximity of magnetic holding devices may interfere with certain magnetically sensitive electronic or other magnetically sensitive devices, and as a result the use of such magnetic holding devices is regulated in certain areas. Because the magnetic attraction force is directly related to the magnitude of the magnetic field, the magnetic attraction force is reduced when the magnetic field strength in any particular holding device is reduced. The magnetic attraction or “pull” force is a critical specification of such magnetic holding devices, and high pull force in a compact package is desired in many circumstances. It is desirable that a design for magnetic holding devices meets the following criteria:
(i) it provides high magnetic pull force to a corresponding ferromagnetic member; and
(ii) it minimizes magnetic leakage field into the surroundings to minimize magnetic interference.

Magnet cup assemblies have been used to obtain high pull force by intensifying the magnetic field strength and gradient in the location where the lip of the cup magnet assembly is either close to or contacts the ferromagnetic member the cup magnet assembly is to hold to. As a byproduct of such design, magnetic field leakage is reduced in the proximity of the cup magnet assembly. However, the leakage field can still prove to be too high to satisfy certain application requirements.

There exists a need for improved magnetic cup assemblies having reduced magnetic field leakage.

### SUMMARY

One aspect of the disclosure is magnetic cup assembly comprising multiple magnetic poles disposed inside a ferromagnetic cup, wherein the magnetic poles are arranged such that a net magnetic sum of the cup assembly on a cup opening side is substantially magnetically neutral.

Other aspects and advantages will be apparent from the description and claims which follow.

### BRIEF DESCRIPTION OF THE DRAWINGS

FIG. 1 shows an example of a magnet cup assembly engaging a ferromagnetic member.

FIG. 2 shows magnetic flux lines linking the magnet cup assembly and ferromagnetic member shown in FIG. 1

FIG. 3 shows a different example of the magnet cup assembly shown in FIGS. 1 and 2.

FIG. 4 shows another example of the magnet cup assembly.

FIG. 5 shows another example of the magnet cup assembly.

FIG. 6 shows another example of the magnet cup assembly.

### DETAILED DESCRIPTION

Magnetic flux lines of a magnet cup assembly as described further herein are for the most part self-contained. As magnetic flux lines form closed loops, they originate from a magnet's North pole, travel through a medium—for example, air, a steel part, or another permanent magnet—and return to the magnet's South pole. Within the magnet, the flux lines return to the North pole to close the loop.

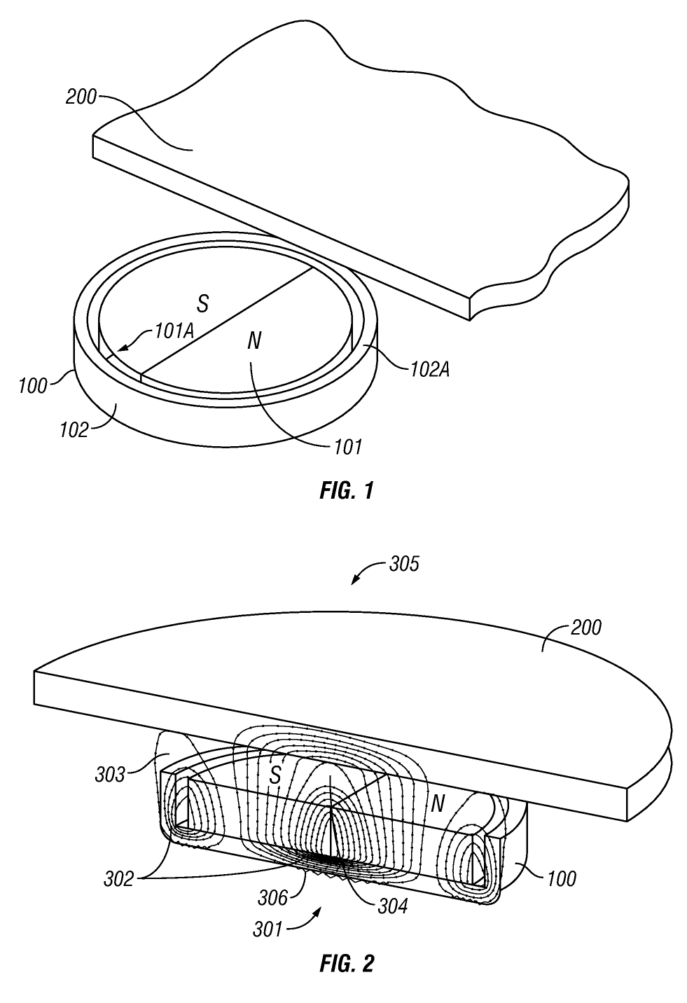

FIG. 1 shows an example of a magnet cup assembly 100 engaging a ferromagnetic member 200. The ferromagnetic member 200 may be made, for example, from steel or magnetic stainless steel. A magnet 101 may be a permanent magnet or electromagnet in the shape of a flat disk, having two opposite magnetic poles S, N on the face thereof. The magnet 101 may also consist of two separate magnets with opposite magnetic orientations, each magnet being a half-disk shape. The magnet 101 resides in and may be concentric to a ferromagnetic (steel or magnetic stainless steel) cup 102. There is a selected clearance 101A between the magnet 101 and the interior wall of the cup 102. The clearance 101A may be sized such that magnetic flux lines link the cup wall to the corresponding ferromagnetic member 200. The top surface of the magnet 101 may be level with or slightly lower than the upper edge 102A of the cup 102 wall.

FIG. 2 shows the magnetic flux lines linking the magnet cup assembly 100 and the ferromagnetic member 200. 301 shows the magnetic flux path in the underside of the magnet cup assembly 100, where the magnetic leakage is low. 302 shows the magnetic flux lines inside the cup 102 wall and the interior of the cup 102 bottom where the magnetic field is high, but the cup 102 itself is not magnetically saturated. 303 shows the magnetic flux lines above the cup lip where the magnetic flux lines link the cup 102 and the ferromagnetic member 200. 304 shows the magnetic flux lines above the boundary of the opposite magnetic poles S, N where the magnetic flux lines link the magnet(s) 101 and the ferromagnetic member 200. 305 shows the apparent magnetic flux at a certain distance straight above the cup 102 opening, from where the magnet cup assembly 100 exhibits substantial magnetic neutrality.

In the present example, the magnetic flux loops flow in two generally definable regions. One region is the in the locality of the cup lip, shown at 303, where the loop links the cup lip to the magnet 101 circumference. The other region is at the boundaries of two opposite magnet poles, 304.

In both regions, if the sizing is appropriate, the magnetic flux line loops link the magnetic cup assembly 100 to the corresponding ferromagnetic member 200, thus forming a strong bond between the two, and creates high pull force. Due to the equality of the magnetic flux surrounding the North and South poles of the magnet 101, the magnet cup assembly 100 exhibits substantial magnetic neutrality at a short distance away from the cup opening, 305. The magnetic neutrality distance may be determined by the magnet size and the amplitude of the magnetic field generated by the magnet. The magnet should therefore have a size and field amplitude suitable for the particular application of the magnet cup. The magnetic flux line self-containment and the magnetic neutrality keep the leakage field to the surroundings low, and thus may substantially eliminate interference with electronics or magnetic sensors located away from the magnet cup assembly 100 in the area 301 below the cup assembly 100.

The magnetic field magnitude inside the cup wall and the cup bottom is not uniform, and can affect the leakage field in the surroundings. The magnetic field near the bottom corner of the cup, shown at 302, is high. The other area where the internal magnetic field is high is in the area below the boundaries between opposite magnet poles, shown at 306. It is important to keep the magnetic field in these regions, 302, 306 below the saturation level of the ferromagnetic material from which the cup 102 is made, so the magnetic flux lines do not leak out of the cup 102 into the surrounding environment, thereby contributing to the surrounding leakage field.

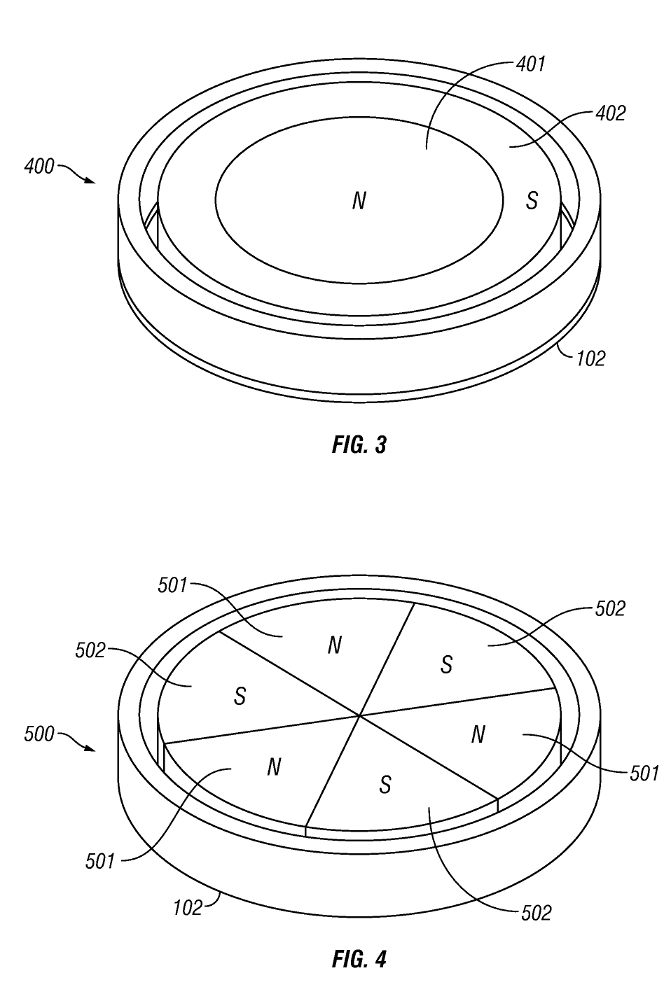

FIG. 3 shows a different example of the magnet cup assembly shown in FIGS. 1 and 2. In FIG. 3 there is a center disk magnet 401 and an outer ring magnet 402 disposed within a magnet cup 102 as described with reference to FIG. 1. The two magnets 401, 402 have opposite magnetic orientations, and most of their magnetic flux lines are self-contained, so that when observed from above the magnet cup assembly 400, there may be observed magnetic neutrality.

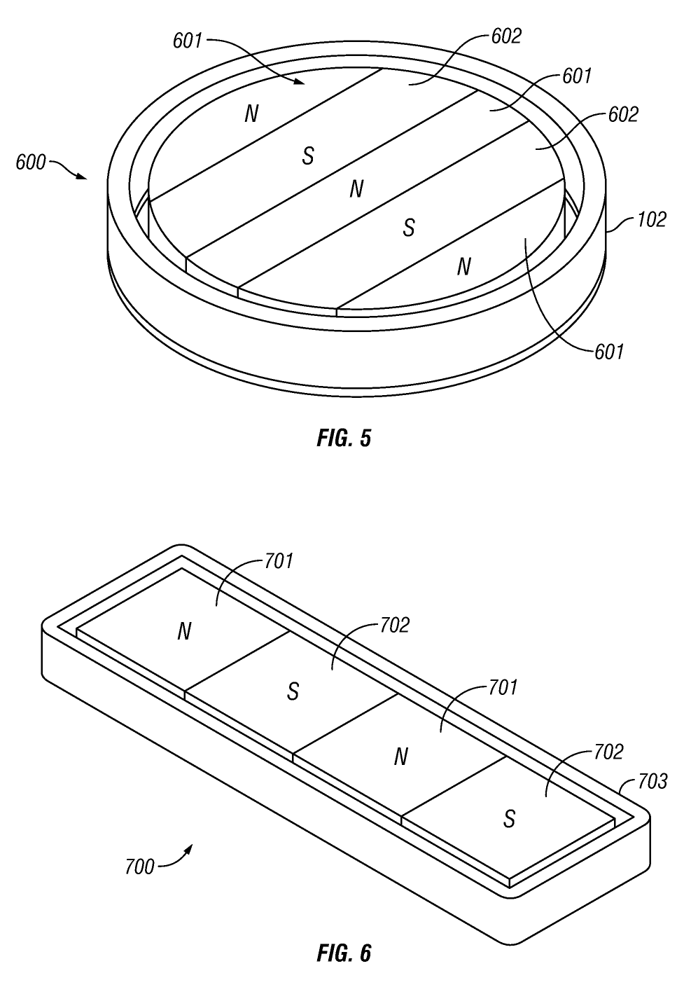

FIG. 4 shows another example of the magnet cup assembly 500. In FIG. 5 the assembly consists of an even number of alternatingly polarized circular-wedge shaped magnets 501, 502, or there could be one magnet magnetized to have multiple magnetic poles as shown in FIG. 4, half of which have North poles pointing up, the other half of which have South poles pointing up. Most of the magnetic flux lines are self-contained, so that when observed from high above the magnet cup assembly 500 there may be observed magnetic neutrality.

FIG. 5 shows another example of the magnet cup assembly 600. In FIG. 5 the assembly consists of a number of bar shaped magnets 601, 602, or there could be one magnet magnetized to have multiple alternating magnetic poles as shown in FIG. 5. Most of the magnetic flux lines are self-contained, so that when observed from above the magnet cup assembly 600 there can be observed magnetic neutrality. Note that the individual magnets in examples having a plurality of magnets do not need to be equal in size in order to obtain magnetic neutrality in the cup assembly as a whole.

FIG. 6 is yet another example of the magnet cup assembly 700. The magnet cup 703 in this case is not circularly shaped as in the previous examples, rather it may be rectangularly channel shaped. Inside the cup 703 may be a single magnet with alternating magnetic poles or a plurality of magnets 701, 702 with opposed pole orientations as shown. Most of the magnetic flux lines are self-contained, so that when observed from high above the channel magnet assembly there may be observed magnetic neutrality.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A magnetic cup assembly comprising:
at least one of a plurality of magnets and a single magnet, the plurality of magnets or the single magnet having multiple magnetic poles disposed inside a ferromagnetic material cup having a closed bottom and an open top, wherein the poles of the single magnet or plurality of magnets are arranged such that there is substantial magnetic neutrality above the open top.

2. The magnetic cup assembly of claim 1 wherein magnetic flux lines link the magnetic cup assembly and a corresponding ferromagnetic member in a plurality of regions comprising: where a cup lip is proximate to the magnet poles; and wherein the corresponding ferromagnetic member is disposed over boundaries between opposite magnetic poles.

3. The magnetic cup assembly of claim 1 wherein a material, a thickness of the material and a magnitude of the field induced by the plurality of magnets or multiply polarized single magnet results in the bottom of the ferromagnetic cup being magnetically undersaturated.

4. The magnetic cup assembly of claim 1 wherein the plurality of magnets or single magnet having a multiple magnetic poles extend at most to an upper edge of a wall of the cup and wherein magnetic pole surfaces are disposed below a cup lip surface.

5. The magnetic cup assembly of claim 1 wherein a selected clearance exists between the circumference of the magnet or magnets and an interior of a wall of the ferromagnetic cup, wherein the clearance is sized such that magnetic flux lines link the cup wall to a corresponding ferromagnetic member.
